(19) United States
(12) Patent Application Publication
(10) Pub. No.: US 2006/0183391 A1
(43) Pub. Date: Aug. 17, 2006

(54) Papermachine fabric

(76) Inventors: Robert Crook, Wilson, NC (US); Ralf Burbaum, Dueren (DE); Hans Ragvald, Vingaker (SE); Hubert Walkenhaus, Kerpen (DE); Achim Lesmeister, Aachen (DE); George Kleiser, Heubach (DE)

Correspondence Address: Robert S. Green;Voith Paper Fabrics, P.O. Box 1411, Wilson, NC, 27894-1411, US

(21) Appl. No.: 11/303,658

(22) Filed: Dec. 15, 2005

(30) Foreign Application Priority Data
Dec. 23, 2004 (DE) 10 2004 062 106.3

(51) Int. Cl. D03D 15/00; D03D 13/00; B32B 5/26

(52) U.S. Cl. 442/203; 442/268; 442/239; 442/208

(57) ABSTRACT

Papermachine fabric, in particular press felt for the press section of a paper machine. A papermachine fabric, for example a press felt for use in the press section of a papermachine, has a thread arrangement oriented in the machine running direction (direction of the x-axis). The thread arrangement has regions of different density, i.e. a different number of threads per cm, transversely with respect to the machine running direction (direction of the y-axis). The fabric is intended to have regions of different properties transversely with respect to the machine running direction.

### CROSS-REFERENCE TO RELATED APPLICATIONS

The present application claims priority under 35 U.S.C. §119 of German Patent Application No. 10 2004 062 106.3 filed on Dec. 23, 2004, the disclosure of which is expressly incorporated by reference herein in its entirety.

### BACKGROUND OF THE INVENTION

1. Field of the Invention

The invention relates to a papermachine fabric, in particular a press felt for the press section of a paper machine.

2. Discussion of Background Information

Papermachine fabrics of this type are known from practice. They are normally produced from a conventional woven textile, which forms a carrier layer, also called a substrate, base or base structure, and a paper-side nonwoven layer joined to the carrier layer. Such papermachine fabrics can have nonwoven materials and usually have in their transverse direction, that is to say in a direction transverse with respect to the longitudinal axis of the fabric and therefore transverse with respect to the machine running direction, an air and/or water permeability which is uniform and constant over the width of the fabric, that is to say in the transverse direction. The drawback here is that the paper web fed to the press section of a paper machine in practical applications frequently exhibits a nonuniform distribution of the moisture in the transverse direction, so that the processing of such a paper web with a different permeability profile transversely with respect to the machine running direction can in any case lead to ineffective dewatering and a shape change of the paper web, if the press felt has a completely uniform permeability in the transverse direction. This can have a detrimental influence on the operating costs of the paper machine and ultimately also on the quality of the paper.

### SUMMARY OF THE INVENTION

The invention is based on the object of providing a papermachine fabric having different properties, in particular different permeabilities, in the transverse direction.

According to the invention, this object is achieved by a papermachine fabric having a thread arrangement oriented substantially in the machine running direction, wherein the thread arrangement comprises at least a first region and a second region, the first region having a first fluid permeability, the second region having a second fluid permeability, and wherein the first fluid permeability of the first region is different from the second fluid permeability of the second region transversely with respect to the machine running direction.

Advantageous developments are the subject matter of the subclaims.

The papermachine fabric according to the invention has a thread arrangement oriented exclusively in the machine running direction. According to the invention, the thread arrangement is formed in such a way that regions with a different fluid permeability transversely with respect to the machine running direction are formed.

In this manner, the dewatering properties of the papermachine fabric can be matched to the different moisture profile in the transverse direction of the paper web, so that ultimately a paper web with a moisture profile that is evened out or uniform in the transverse direction is produced.

One embodiment of the invention provides for the density of the threads per cm and/or for the diameter of the threads to vary transversely with respect to the machine direction.

With the aid of the regions of different thread density per cm and/or of different thread diameter, different permeabilities in the transverse direction of the fabric can be set virtually as desired, in accordance with the specific requirements of the respective application. As a result, the papermachine fabric according to the invention is capable of correcting or adjusting the moisture profile in the paper web to a certain extent and to equate the regions of different density locally to the course of the moisture profile in the paper web. Regions with increased moisture in the paper web should in this case be opposite regions with a low density and/or low thread diameter and thus an increased permeability on the part of the papermachine fabric. Conversely, regions in the paper web with less moisture should be opposite regions on the part of the fabric having increased density and/or increased thread thickness and therefore lower permeability. The papermachine fabric constructed in accordance with the invention can thus be formed with a variable profile and, during its production, can be adapted to the specific requirements and conditions of a specific paper machine. Other parameters of the papermachine fabric, such as stability, wear resistance, dewatering capacity, lifetime, are intended to remain unchanged.

The density of the thread arrangement in the transverse direction is preferably about 8 to 20 threads per cm. In this manner the resultant permeability of the papermachine fabric can be varied within wide limits along its width.

According to another embodiment of the invention, the regions of different density are arranged symmetrically or asymmetrically with respect to the machine running direction, i.e. to the longitudinal axis of the fabric. This creates a further possible way of being able to adapt the papermachine fabric without difficulty to the states prevailing in a specific paper machine.

According to another embodiment, the threads are produced from polyamide (PA), polyethylene (PE) or polyethylene terephthalate (PET) and preferably have a diameter of approximately 0.05 to 0.3 mm. This makes it possible to influence the density of the thread arrangement both by means of the diameter of the individual threads and by means of their spacing.

The threads are preferably monofilaments or multifilament threads. The papermachine fabric according to the invention can therefore be varied within wide limits.

According to another embodiment of the invention, the papermachine fabric according to the invention comprises, in addition to the above-mentioned thread arrangement oriented substantially in the machine direction, at least one nonwoven layer and/or a woven base structure and/or a nonwoven grid structure and/or a thread arrangement arranged substantially in the cross machine direction and/or a permeable or semipermeable layer.

The at least one nonwoven layer can in this case be arranged as an intermediate layer between other layers or as an external layer, for example on the paper side of the papermachine fabric.

The fibers forming the nonwoven layer preferably comprise a suitable polymer material, such as PA6, PA66, PA6.10, PA6.12, or PET.

Furthermore, the membrane and/or the grid structure preferably comprises an elastomer polymer material.

It is therefore possible to provide a modular papermachine fabric, in particular a press felt, with properties that can be matched to the respective requirements, in which, within wide limits, the permeability can be varied in the transverse direction and can be matched to the state of the paper web in some sections or regions, so to speak. It is clear that the basic structure brings about the longitudinal and transverse stability of the fabric and, in particular, ensures the tensile strength in the machine running direction. By means of the aforementioned construction, the resilience of the fabric in the direction of its thickness is also improved.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a schematic, partial plan view of a thread arrangement of a papermachine fabric according to a first embodiment; and

FIG. 2 shows a schematic, partial plan view of a thread arrangement of a papermachine fabric according to another embodiment.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

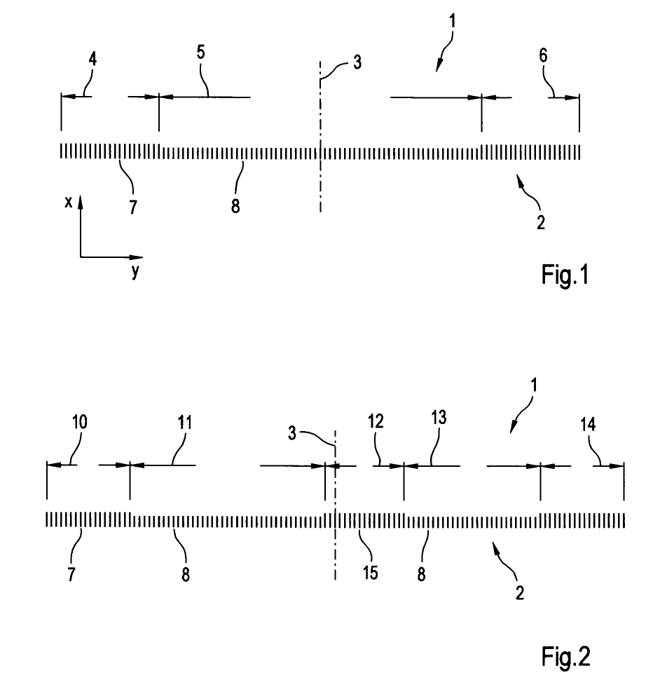

In FIG. 1, according to a first embodiment, a thread arrangement 2 of a papermachine fabric 1 oriented substantially in the machine direction is illustrated schematically in a partial plan view. A second embodiment of a thread arrangement 2 of the papermachine fabric 1 is illustrated schematically in FIG. 2.

The papermachine fabric is in particular but not exclusively a press felt for the press section of a paper machine, not specifically shown. The thread arrangement 2 of the papermachine fabric 1 is oriented unidirectionally in the machine running direction. The machine running direction runs in the direction of the x-axis in FIG. 1, the direction transverse with respect to the machine running direction therefore corresponds to the y-axis of the coordinate system shown in FIG. 1.

In FIGS. 1 and 2, the longitudinal axis 3 of the papermachine fabric 1 is also shown, which extends in the direction of the x-axis, that is to say in the machine running direction.

According to the invention, the thread arrangement 2 transverse with respect to the machine running direction, that is to say in the direction of the width of the fabric, which extends in the direction of the y-axis, has regions 4 to 6 of different density, that is to say a different number of threads 7, 8 per cm. In the exemplary embodiment according to FIG. 1, three such regions are illustrated, in the exemplary embodiment according to FIG. 2, five regions 10 to 14 are illustrated.

In FIG. 1, the threads 7 are located in the outer regions 5 and 6, and the threads 8 in the central region 5 of the thread arrangement 2. The outer regions 4 and 6 are characterized by a lower density, the central region 5 by a higher thread density.

In the embodiment shown in FIG. 2, the threads 7 are assigned to the outer regions 10 and 14, the threads 8 to the regions 11 and 13 located further in and threads 15 to the region 12, through which the longitudinal axis 3 extends.

The density of the thread arrangement 2 transversely with respect to the machine running direction, that is to say in the direction of the y-axis and therefore in the direction of the width of the thread arrangement and/or of the fabric, is 8 to 20 threads 6, 7, 15 per cm. The regions 4 to 6 and 10 to 14 of different density are arranged symmetrically, as shown in the embodiment according to FIG. 1, or, as shown in the embodiment according to FIG. 2, asymmetrically in relation to the machine running direction, that is to say to the longitudinal axis 3 of the fabric 1.

The threads 7, 8, 15 are produced, for example, from polyamide (PA), polyethylene (PE) or polyethylene terephthalate (PET). They usually have a diameter of 0.05 to 0.3 mm. As indicated in FIGS. 1 and 2, the threads 7 have a larger diameter than the threads 8, and the threads 15 in turn have a larger diameter than the threads 7. To this extent, the region 12 in FIG. 2 has the lowest density and therefore the highest permeability, the regions 11 and 13 have the highest density and the regions 10 and 14 have a density which lies between that of the region 12, on the one hand, and the regions 11 and 13, on the other hand.

The threads 7, 8, 15 are what are known as monofilaments or multifilament threads.

According to a preferred embodiment of the invention, the fabric 1 is a press felt.

In addition to the thread arrangement 2, the papermachine fabric 1 comprises at least one nonwoven layer and/or a woven base structure and/or a nonwoven grid structure and/or a thread arrangement arranged substantially in the cross machine direction and/or a permeable or semipermeable layer, which are not shown in the illustrations of FIGS. 1 and 2 for reasons of clarity.

As previously mentioned, the thread system is oriented exclusively in the machine running direction, i.e. in the direction of the x-axis, and therefore unidirectionally. It follows from this that the threads 7, 8, 15 extend with their respective longitudinal axis in the machine running direction and are arranged beside one another in order to form the thread arrangement 2. However, the thread arrangement could, for example, also be part of a woven structure. Such a structure would then comprise a thread arrangement arranged in the machine direction and a thread arrangement arranged in the cross machine direction, it being possible for the fluid permeability transversely with respect to the machine direction to be adapted in accordance with the respective requirements, for example by means of a density of the threads per cm changing in the cross machine direction and/or by means of a thread diameter changing in the cross machine direction. It is clear that the individual regions 4 to 6 and 10 to 14 of different density are arranged to be distributed over the width of the papermachine fabric 1 in a manner which corresponds to the moisture profile in the paper web transversely with respect to the machine running direction. The action of such a regional change in the permeability of the paper machine fabric, and therefore also of the dewatering capacity within the finished paper machine fabric, permits optimal, preferred adaptation of the fabric to irregularities with regard to the moisture profile or the press profile transversely with respect to the machine running direction. The papermachine fabric according to the invention therefore provides an equalized moisture profile in the paper web leaving the nip or the press section.

A papermachine fabric is therefore provided which has different properties in some regions transversely with respect to the machine running direction.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Charges may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

We claim:

1. A papermachine fabric having a thread arrangement oriented substantially in the machine running direction, wherein the thread arrangement comprises at least a first region and a second region, the first region having a first fluid permeability, the second region having a second fluid permeability, and wherein the first fluid permeability of the first region is different from the second fluid permeability of the second region transversely with respect to the machine running direction.

2. The papermachine fabric of claim 1, wherein the papermachine fabric is a press fabric.

3. The papermachine fabric as claimed in claim 1, wherein density of the threads in at least one of per cm and diameter of the threads varies transversely with respect to the machine direction.

4. The papermachine fabric as claimed in claim 3, wherein the density of the thread arrangement is approximately 8 to 20 threads per cm.

5. The papermachine fabric as claimed in claim 3, wherein the first region has a first thread density and the second region has a second thread density, and wherein the first thread density and the second thread density are arranged symmetrically with respect to the machine running direction.

6. The papermachine fabric as claimed in claim 3, wherein the first region has a first thread density and the second region has a second thread density, and wherein the first thread density and the second thread density are arranged asymmetrically with respect to the machine running direction.

7. The papermachine fabric as claimed in claim 3, wherein the first region has a first thread density and the second region has a second thread density, and wherein the first thread density and the second thread density are not equal.

8. The papermachine fabric as claimed in claim 1, wherein the thread arrangement is part of a woven structure.

9. The papermachine fabric as claimed in claim 1, wherein the threads are produced from at least one of polyamide (PA), polyethylene (PE) and polyethylene terephthalate (PET).

10. The papermachine fabric as claimed in claim 1, wherein the threads have a diameter of approximately 0.05 to 0.3 mm.

11. The papermachine fabric as claimed in claim 1, wherein the threads are at least one of monofilaments and multifilament threads.

12. The papermachine fabric as claimed in claim 1, wherein the fabric comprises at least one of a nonwoven layer, a woven base structure, a nonwoven grid structure and a thread arrangement arranged substantially in at least one of the cross machine direction, a permeable layer and a semipermeable layer.

13. The papermachine fabric as claimed in claim 12, wherein at least one of the permeable layer, the semipermeable layer and the grid structure comprises an elastomer polymer material.

14. The papermachine fabric as claimed in claim 1, wherein the fabric comprises a nonwoven layer, and wherein threads forming the nonwoven layer comprise a polymer material.

15. The papermachine fabric as claimed in claim 14, wherein the polymer material is at least one of PA6, PA66, PA6.10, PA6.12, and PET.
